(19) United States
(12) Patent Application Publication
(10) Pub. No.: US 2024/0426140 A1
(43) Pub. Date: Dec. 26, 2024

(54) METHOD FOR CONTROLLING A FRAME LOCK OF A VEHICLE

(71) Applicant: ABUS August Bremicker Söhne KG, Wetter-Volmarstein (DE)

(72) Inventor: Stefan HEINEMANN, Wetter (DE)

(21) Appl. No.: 18/740,658

(22) Filed: Jun. 12, 2024

(30) Foreign Application Priority Data
Jun. 20, 2023 (DE) 102023116136.9

(51) Int. Cl. E05B 71/00; E05B 47/00

(52) U.S. Cl. CPC E05B 71/00; E05B 47/0012

(57) ABSTRACT

The invention relates to a method for controlling a frame lock of a vehicle that comprises an electric drive motor, a control unit for controlling the drive motor and a frame lock attached to a frame of the vehicle, wherein the frame lock has a closing hoop, which can be manually brought by a user from an open position into a closed position, and an electrically actuable locking element that locks the closing hoop both in the open position and in the closed position and that can be moved by an electric actuator of the frame lock into an unlocking position releasing the closing hoop, wherein the actuator of the frame lock is connected to the control unit and receives an unlocking signal from the control unit for moving the locking element into the unlocking position releasing the closing hoop when the control unit is switched on or off.

### CROSS-REFERENCE TO RELATED APPLICATION

This application claims the benefit and priority of German Patent Application No. 102023116136.9 filed on Jun. 20, 2023. The entire disclosure of the above application is incorporated herein by reference.

### FIELD OF THE INVENTION

The invention relates to a method for controlling a frame lock of a vehicle that comprises an electric drive motor, a control unit for controlling the drive motor and a frame lock attached to a frame of the vehicle, wherein the frame lock has a closing hoop, which may be manually brought by a user from an open position into a closed position, and an electrically actuable locking element that locks the closing hoop both in the open position and in the closed position and that may be moved by an electric actuator of the frame lock into an unlocking position releasing the closing hoop.

### BACKGROUND OF THE INVENTION

Such a frame lock is generally known and is usually used at a bicycle. It is also referred to as a semi-automatic frame lock since the release of the closing hoop indeed takes place automatically, in particular electrically, but the closing hoop itself must be manually brought by the user from the open position into the closed position. Conventionally, such a semi-automatic frame lock may be directly coupled to a smartphone and may then be controlled by an app installed on the smartphone.

### SUMMARY OF THE INVENTION

It is the underlying object of the invention to provide a more user-friendly method for controlling a frame lock.

The object is satisfied by a method for controlling a frame lock of a vehicle having the features of claim 1 and in particular in that the actuator of the frame lock is connected to the control unit and receives an unlocking signal from the control unit for moving the locking element into the unlocking position releasing the closing hoop when the control unit is switched on or off.

In this connection, a vehicle is, for example, understood as an electric bicycle, in particular an e-bike or a pedelec, an electric tricycle, an electric wheelchair, an electric quad bike or the like.

The idea according to the invention is to no longer couple the frame lock directly to the smartphone of a user, but instead to connect it to the control unit of the vehicle and to control it by switching the control unit on or off. A coupling of the frame lock to the smartphone of a user and a control of the frame lock via an app installed on the smartphone may thus be omitted, whereby the ease of use of the frame lock and thus of the vehicle as a whole is thus increased significantly.

According to the invention, the control unit is the control unit that serves to control the drive motor, i.e. the central control unit of the vehicle that is often also referred to as the on-board computer. The control unit may be mounted on the handlebars of the vehicle so that the control unit may be easily operated by the user of the vehicle during travel and/or a display of the control unit is clearly visible during travel.

Advantageous further developments of the invention can be seen from the dependent claims, from the description, and from the drawing.

According to one embodiment, the control unit may carry out an authentication of the user when switching on and may only transmit an unlocking signal to the actuator of the frame lock if the user has been positively authenticated. This helps to prevent an unauthorized opening of the frame lock and thus improves theft protection.

It is generally conceivable to connect the actuator of the frame lock to the control unit by means of a short-range wireless communication link. However, it is more cost-effective and secure if the actuator of the frame lock is connected to the control unit in a wired manner.

According to a further embodiment, the control unit may authenticate the actuator of the frame lock after switching on or switching off and (a) may transmit the unlocking signal to the actuator of the frame lock in the event of a positive authentication and/or (b) may output an error message to the user in the event of a negative authentication and, in the event of a switching off of the control unit, may then shut down. Due to the authentication of the actuator of the frame lock by the control unit, it is ensured that the actuator of the frame lock may only be controlled by a control unit associated with the frame lock, i.e. a legitimate control unit. In this way, the actuator of the frame lock is prevented from being moved in an unauthorized manner by a third-party control unit into the unlocking position releasing the closing hoop and the theft protection is improved even further.

So that the frame lock may not close while the wheels of the vehicle are turning, the control unit may check the movement status of the vehicle in the event of a switching off of the control unit and may only transmit the unlocking signal to the actuator of the frame lock when the vehicle is stationary.

For even greater ease of use, the actuator of the frame lock may, after receiving the unlocking signal, move the locking element into the unlocking position releasing the closing hoop for a first predetermined time period, for example for a period of up to several tens of seconds, in particular 10 s to 60 s and preferably 10 s to 30 s. In other words, the first predetermined time period defines a time window during which the user may move the closing hoop from the open position into the closed position after the control unit has been switched off or, if applicable, may move the closing hoop from the closed position into the open position after the control unit has been switched on.

According to a further embodiment, the control unit may be connected to a sensor for detecting the open position and closed position of the closing hoop and the control unit (a) may confirm a locking of the frame lock to the user and may then shut down if the closing hoop was brought from the open position into the closed position within the first predetermined time period, or (b) may output an error message to the user and may then shut down if the closing hoop was not brought from the open position into the closed position within the first predetermined time period. The sensor may, for example, be a magnetic sensor.

Accordingly, the control unit may (a) confirm an opening of the frame lock to the user if the closing hoop was brought from the closed position into the open position within the first predetermined time period, or may (b) output an error message to the user if the closing hoop was not brought from the closed position into the open position within the first predetermined time period.

For an even further increase in the ease of use, the closing hoop may be able to be brought from the open position into the closed position against the spring force of a return spring. The return spring thus causes the frame lock to spring open automatically, i.e. the closing hoop assumes its open position as soon as the actuator of the frame lock receives an unlocking signal from the control unit and releases the closing hoop. A manual actuation of the closing hoop by the user is therefore only required for locking the frame lock.

According to a further embodiment, the control unit may be connected, in particular in a wired manner, to an electric actuator of a battery compartment lock of the vehicle by which the battery compartment lock may be unlocked to enable a removal of a battery received in the battery compartment. This battery may in particular be the battery that is intended to supply the drive motor with electrical energy and that is also referred to here as the main battery. The battery is preferably rechargeable.

If the user would like to remove the battery from the battery compartment while the control unit is switched on, the control unit may transmit an unlocking signal for unlocking the battery compartment lock to the actuator of the battery compartment lock in response to a manual user input at the control unit.

Alternatively or additionally, in the event of a switching off of the control unit, the control unit may then automatically transmit an unlocking signal to the actuator of the battery compartment lock if the closing hoop of the frame lock has previously been brought from the open position into the closed position. If the frame lock has been locked, the user therefore also has the possibility of removing the battery when the control unit is switched off. If the frame lock is supplied with electrical energy solely by this battery, i.e. the main battery, it is ensured by querying the position of the closing hoop that the user locks the frame lock before he may remove the battery. However, it is also conceivable that a separate frame lock battery is provided in addition to the main battery and enables an actuation of the frame lock independently of the main battery.

Similarly to the control of the frame lock, the control unit may, in order to avoid an unauthorized removal of the battery, authenticate the actuator of the battery compartment lock and (a) may transmit the unlocking signal to the actuator of the battery compartment lock in the event of a positive authentication and/or (b) may output an error message to the user in the event of a negative authentication and, in the event of a switching off of the control unit, may then shut down.

Furthermore, similarly to the actuator of the frame lock, the actuator of the battery compartment lock may, after receiving the unlocking signal, also unlock the battery compartment lock for a second predetermined time period, for example for a period of up to several tens of seconds, in particular 10 s to 60 s and preferably 10 s to 30 s. The first and second predetermined time periods may have the same length or different lengths.

Accordingly, the actuator of the battery compartment lock may automatically lock the battery compartment lock again after the second predetermined time period has elapsed and the battery has not been removed and, in the event of a switching off of the control unit, the control unit may shut down.

A further object of the invention is a vehicle comprising an electric drive motor, a control unit for controlling the drive motor, a frame and a frame lock attached to the frame, wherein the frame lock has a closing hoop, which may be manually brought by a user from an open position into a closed position, and an electrically actuable locking element that locks the closing hoop both in the open position and in the closed position and that may be moved by an electric actuator of the frame lock into an unlocking position releasing the closing hoop, wherein the actuator of the frame lock is connected to the control unit, and wherein the control unit is configured such that, when switching on and off, said control unit transmits a respective unlocking signal to the actuator of the frame lock for moving the locking element into the unlocking position releasing the closing hoop. The above-mentioned advantages may be correspondingly achieved by this vehicle.

### DRAWINGS

The invention will be described in the following purely by way of example with reference to possible embodiments and to the enclosed drawing. There are shown:

FIG. 1 is a schematic representation of a bicycle with a drive motor, a control unit, a frame lock and a battery compartment lock;

FIGS. 2A and 2B are schematic representations of the frame lock with different positions of a closing hoop of the frame lock;

FIG. 3 is a flowchart of an opening of the frame lock;

FIG. 4 is a flowchart of a locking of the frame lock; and

FIG. 5 is a flowchart of a locking of the frame lock and an opening of the battery compartment lock.

### DETAILED DESCRIPTION OF THE INVENTION

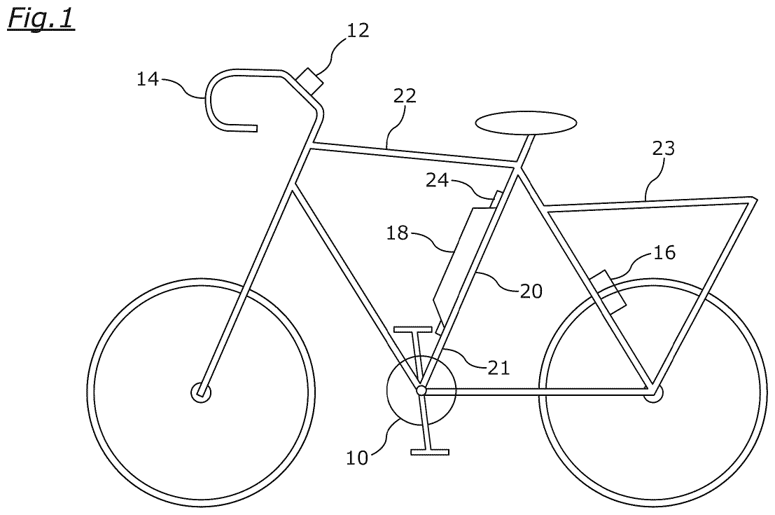

FIG. 1 shows a bicycle, more precisely an electric bicycle, for example an e-bike or a pedelec, that is equipped with an electric drive motor 10. In the present embodiment, the drive motor 10 is arranged in the region of a bottom bracket of the bicycle. It is, however, equally possible to attach the drive motor 10 to a front wheel hub or to a rear wheel hub of the vehicle.

A control unit 12 comprising a display is provided to control the drive motor 10. At least the display, alternatively the entire control unit 12, is attached in the region of handlebars 14 of the bicycle and may be removed by a user of the bicycle when leaving the bicycle.

The bicycle further has a frame lock 16 that is mounted at the rear wheel spokes of the bicycle and that is likewise controlled by the control unit 12, as described in more detail below.

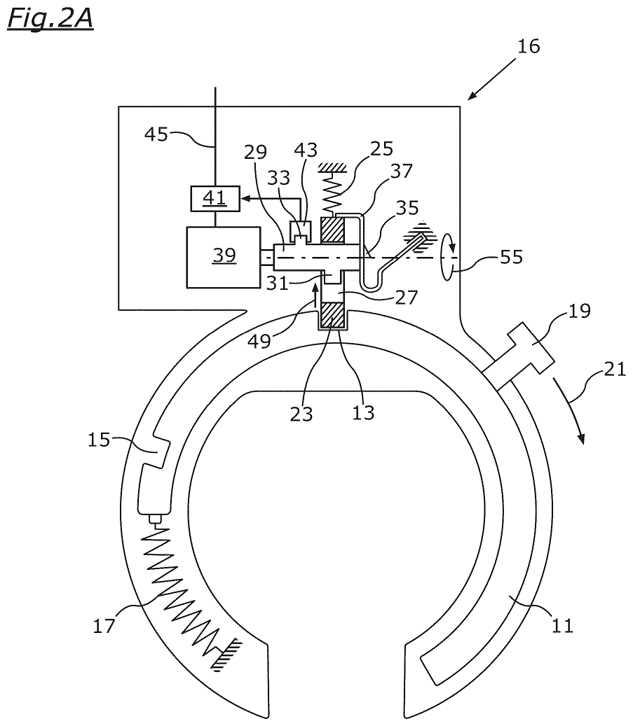

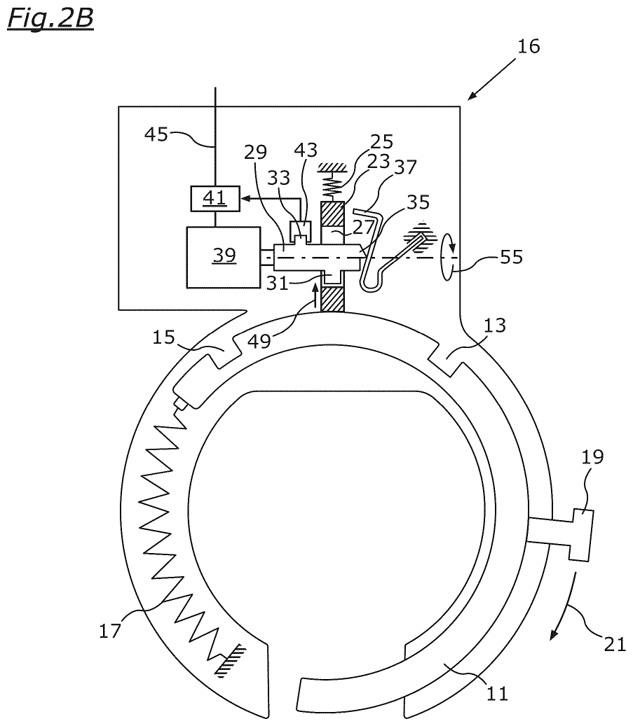

The design of the frame lock 16 is schematically shown in FIG. 2A. The frame lock 16 has a closing hoop 11 configured as a round hoop for engaging around the rear wheel. The closing hoop 11 has an open position-engagement recess 13 and a closed position-engagement recess 15 and is preloaded by means of a tension spring 17 towards an open position shown in FIG. 2A. As long as the closing hoop 11 is not locked, it may be rotated by means of a handle 19 against the preload along a closing direction 21 towards a closed position.

A locking element 23, according to this embodiment in the form of a latch 23, cooperates with the closing hoop 11 and is preloaded by a compression spring 25 towards a locking position shown in FIG. 2A. The latch 23 has a central recess 27. A shaft 29 that has an unlocking cam 31 in the region of the latch 23 engages into said central recess 27. At another longitudinal section, the shaft 29 has a switching cam 33. The front side of the shaft 29 is designed as an eccentrically arranged inclined surface in the form of a release nose 35. Said release nose 35 cooperates with a blocking spring 37, as will be explained below.

An electric actuator 39 is provided as the drive device for the shaft 29, hereinafter referred to as the first actuator 39, in the present embodiment an electric motor that preferably has an integrated or mounted gear for a slowing down (not shown). A controller 41 is associated with the first actuator 39 and is connected at the input side to a contact switch 43 that cooperates with the switching cam 33 of the shaft 29. Furthermore, the controller 41 is connected in a wired manner to the control unit 12 via an electrical line 45, wherein the electrical line 45 serves not only to supply the first actuator 39 and the controller 41 with electrical energy, but also to transmit control signals.

The frame lock 16 shown in FIG. 2A serves to secure the bicycle against an unauthorized use. For this purpose, the closing hoop 11 may be manually brought by the user of the bicycle starting from the open position shown into a closed position in which the closing hoop 11 engages into an intermediate space between two adjacent spokes of the rear wheel and hereby locks the rear wheel. The controller 41 is connected to a sensor, not shown, e.g. a magnetic sensor, that may be used to detect whether the closing hoop 11 is in its open position or in its closed position.

The closing hoop 11 may be locked by means of the latch 23 both in the open position shown and in said closed position. For this purpose, the compression spring 25 urges the latch 23 towards the closing hoop 11. As long as the shaft 29, with the unlocking cam 31, releases the latch 23 for this purpose, the latch 23 therefore contacts the upper side of the closing hoop 11 or engages into one of the two engagement recesses 13, 15 if they are at the level of the latch 23. If the latch 23 engages into the open position-engagement recess 13, the closing hoop 11 is secured in the open position, as shown in FIG. 2A. If, however, the latch 23 engages into the closed position-engagement recess 15, this corresponds to said closed position of the closing hoop 11.

By rotating the shaft 29, the latch 23 may be briefly brought into an unlocking position by means of the unlocking cam 31 along an unlocking direction 49 against the preload by the compression spring 25. In this unlocking position, the closing hoop 11 is released for a rotary movement. In particular, starting from the open position in accordance with FIG. 2A, the user may move the closing hoop 11 along the closing direction 21 by means of the handle 19 in order to ultimately move the closing hoop 11 into the closed position already explained. FIG. 2B shows the frame lock during such a movement of the closing hoop 11 in the closing direction 21. If, at this point in time, the unlocking cam 31 of the shaft 29 already releases the latch 23 again and the compression spring 25 thus urges the latch 23 towards the closing hoop 11 again, this does not affect the further closing movement of the closing hoop 11. As shown in FIG. 2B, the latch 23 is namely only in contact with the upper side of the closing hoop 11 until the closed position-engagement recess 15 is at the level of the latch 23. The latch 23 may then snap into the closed position-engagement recess 15 to secure the closing hoop 11 in the closed position thus reached.

The following property of the frame lock 16 shown can also be seen from FIG. 2B: If the user does not complete the closing actuation during the closing movement of the closing hoop 11—i.e. while the latch 23 is located between the open position-engagement recess 13 and the closed position-engagement recess 15—and the latch 23 thus does not enter into engagement with the closed position-engagement recess 15, the tension spring 17 pulls the closing hoop 11 back into the open position shown in FIG. 2A, wherein the latch 23 then snaps into the open position-engagement recess 13 due to its preload (cf. FIG. 2A). The closing hoop 11 is hereby secured against an unauthorized or unintentional subsequent closing actuation. The same also applies in the event that, in the open position of the closing hoop 11 shown in FIG. 2A, the latch 23 is briefly unlocked as a result of a closing command received from the control unit 12, but the closing hoop 11 is not rotated at all in the closing direction 21 during this time interval. In this case, the closing hoop 11 therefore remains in the open position and the latch 23 immediately re-engages into the open position-engagement recess 13 as soon as the latch 23 has been released for this purpose due to a corresponding rotary movement of the shaft 29.

A further peculiarity of the frame lock 16 shown is the blocking spring 37. As long as the latch 23 is—as shown in FIG. 1A—in the locking position, the blocking spring 37 engages behind the latch 23. This applies both to the open position shown in FIG. 2A and to the explained closed position of the closing hoop 11. As long as the blocking spring 37 engages behind the latch 23 in this way, said latch 23 is secured against an unauthorized unlocking movement according to the so-called “hammer blow method”. To release the latch 23 for an (authorized) movement in the unlocking direction 49, the blocking spring 37 is briefly urged back against the preload exerted by it in order to bring the free end of the blocking spring 37 out of engagement with the latch 23 (cf. FIG. 2B). For this purpose, the release nose 35 of the shaft 29 engages at a compulsory guidance surface of the blocking spring 37 that surrounds a blocking recess of the blocking spring 37 (not shown). However, as soon as the release nose 35 engages into the blocking recess 53, the blocking spring 37 may, due to its preload, engage behind the latch 23 in the manner explained (cf. FIG. 2A).

A rechargeable battery 18, which is received in a battery compartment 20 and which is formed at a seat tube 21 of a frame 22 of the vehicle, is provided to supply the drive motor 10, the control unit 12 and the frame lock 16 with electric energy. Alternatively, it is possible to integrate the battery 18 and the battery compartment 20 into a luggage carrier 23 of the vehicle.

The battery 18 has a power connection, not shown, that enables a charging of the battery 18 directly at the bicycle. The battery 18 may furthermore be removed from the battery compartment 20 for maintenance purposes or replacement purposes or for a charging remote from the bicycle.

To prevent an unauthorized removal and an unintended falling of the battery 18 out of the battery compartment 20, a battery lock 24 is provided that secures the battery 18 in the battery compartment 20. In the present embodiment, the battery lock 24 is integrated into the battery compartment 20 and is configured such that it automatically adopts a locked state as soon as the battery 18 is inserted into the battery compartment 20, for example in that a latch, not shown, preloaded by a spring latches into a latching recess of the battery 18 or of a battery housing or blocks a lever pivoted on the insertion of the battery 18. In this way, the battery 18 received in the battery compartment 20 is normally secured by the locked battery lock 24.

The unlocking of the battery lock 24 takes place electrically and is likewise controlled by the control unit 12, as described in more detail below.

For this purpose, the battery lock 24 comprises an electric actuator, which is not shown and which is connected in a wired manner to the control unit 11 via an electrical line not shown, hereinafter referred to as the second actuator, by which the latch of the battery lock 24 may be brought at least temporarily into an unlocking position releasing the battery 18 against the return force of the spring. For example, the second actuator may comprise an electric motor and an eccentric element that is connected between the electric motor and the latch. Alternatively, the second actuator may comprise an electromagnetic actuator; for example, the latch may be formed from a magnetic material and may form an armature surrounded by a coil.

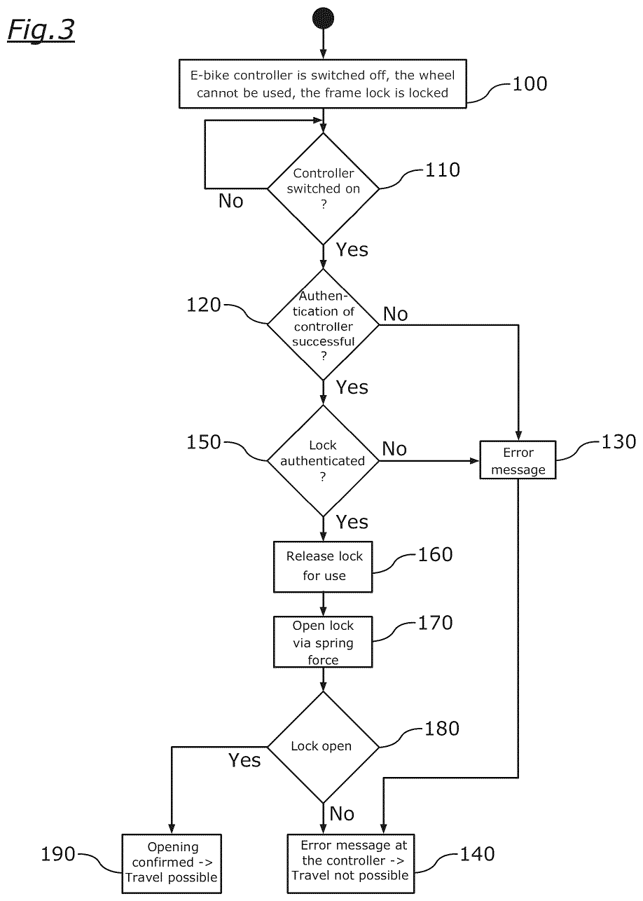

The process of unlocking the frame lock 16 will now be explained in detail with reference to FIG. 3. The initial situation 100 here is a locked frame lock 16 and a switched-off control unit 12.

To start up the bicycle and open the frame lock 16, the user switches on (110) the control unit 12. After the switching on, the control unit 12 checks the identity of the user (120), for example, by means of a code entered by the user or by authenticating a mobile end device of the user, e.g. his smartphone. Alternatively, the authentication may also take place by a remote control or by a removable part of the control unit 12, e.g. by the display of the control unit 12.

If the user is not positively authenticated, the control unit 12 generates an error message (130) that may, for example, be displayed on the display of the control unit 12 (140). An opening of the frame lock 16 is not permitted in this case and the drive motor 10 of the bicycle is not activated either.

In the event of a positive authentication of the user, the control unit 12 next authenticates the frame lock 16 (150), more precisely the first actuator 39 of the frame lock 16. If the first actuator 39 is not positively authenticated, the control unit 12 generates an error message (130) that may, for example, be displayed on the display of the control unit 12 (140). An opening the frame lock 16 is not permitted in this case and the drive motor 10 of the bicycle is not activated either.

In the event of a positive authentication of the frame lock 16, the control unit 12 transmits an unlocking signal to the first actuator 39 (160) and the first actuator 39 moves the latch 23 into the unlocking position releasing the closing hoop 11 (cf. FIG. 2B).

The closing hoop 11 is then pulled by the tension spring 17 into the open position shown in FIG. 2A (170) and the frame lock 16 is opened (180). The opening of the frame lock 16 is confirmed to the user by the control unit 12 (190), e.g. by outputting a corresponding message on the display of the control unit 12.

If, on the other hand, the closing hoop 11 does not reach its open position, for example because the user is holding the closing hoop 11 in the closed position or because a movement of the closing hoop 11 is blocked for another reason, e.g. a mechanical defect, the control unit 12 generates an error message (140) that may, for example, be displayed on the display of the control unit 12 and the drive motor 10 of the bicycle is not activated.

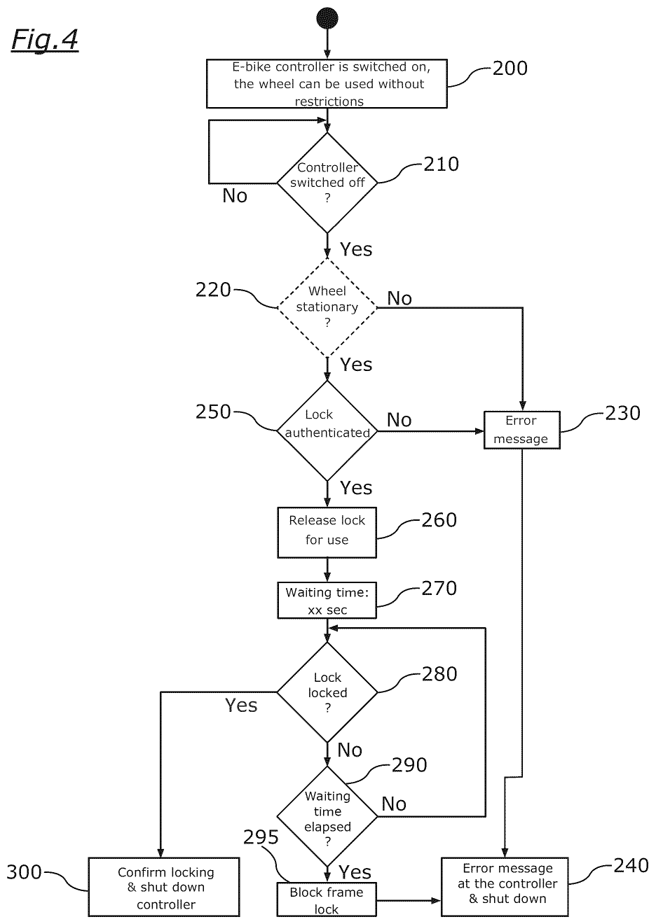

The basic process of locking the frame lock 16 is now explained in more detail with reference to FIG. 4. The initial situation (200) here is an open frame lock 16 and a switched-on control unit 12.

To park and leave the bicycle securely and lock the frame lock 16, the user switches off the control unit 12 (210). Before shutting down, the control unit 12 first checks, for example based on the rotational speed of at least one wheel, whether the bicycle is still moving (220).

If the control unit 12 detects that the bicycle is not stationary, the control unit 12 generates an error message (230) that may, for example, be displayed on the display of the control unit 12. The control unit 12 then shuts down without the frame lock 16 being locked (240).

If, on the other hand, the standstill of the bicycle is verified, the control unit 12 next authenticates the frame lock 16, more precisely the first actuator 39 of the frame lock 16 (250). If the first actuator 39 is not positively authenticated, the control unit 12 generates an error message (230) that may, for example, be displayed on the display of the control unit 12. The control unit 12 then shuts down without the frame lock 16 being locked (240).

In the event of a positive authentication of the frame lock 16, the control unit 12 transmits an unlocking signal to the first actuator 39 (260) and the first actuator 39 moves the latch 23 into the unlocking position (270) releasing the closing hoop for a first predetermined time period, for example for a period of up to several tens of seconds, in particular 10 s to 60 s and preferably 10 s to 30 s (cf. FIG. 2B). During this first predetermined time period, the user may bring the closing hoop 11 of the frame lock 16 into the closed position, i.e. lock the frame lock 16.

During the first predetermined time period, the control unit 12 checks the closed state of the frame lock 16 (280) by means of the sensor connected to the controller 41.

If the first predetermined time period elapses (290) without the closing hoop 11 having been brought into the closed position, the closing hoop 11 is locked again (295) by the first actuator 39 and the control unit 12 generates an error message that may, for example, be displayed on the display of the control unit 12 (240). The control unit 12 then shuts down without the frame lock 16 being locked.

However, if the closing hoop 11 reaches its closed position before the predetermined time period has elapsed, the control unit 12 confirms the locking of the frame lock 16 to the user, e.g. by outputting a corresponding message on the display of the control unit 12. The control unit 12 then shuts down (300).

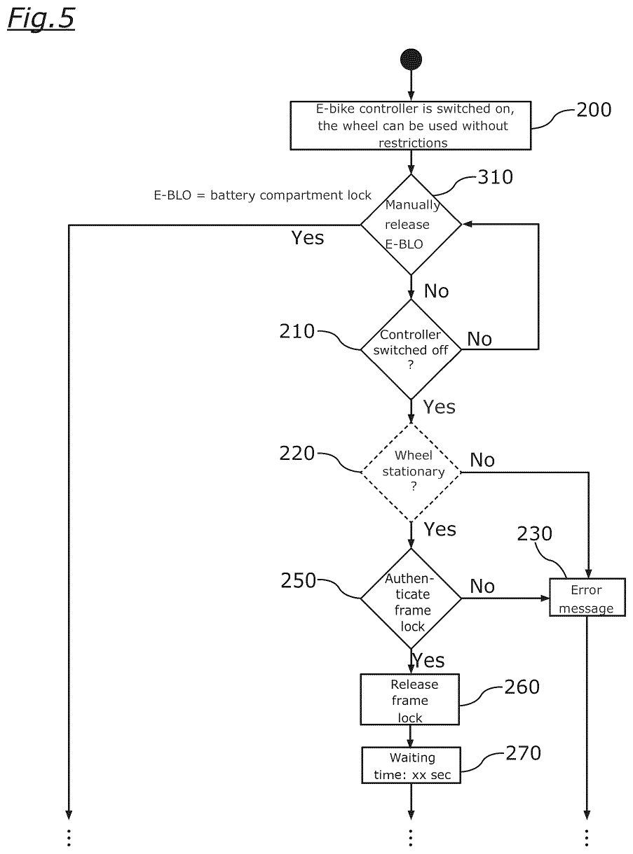

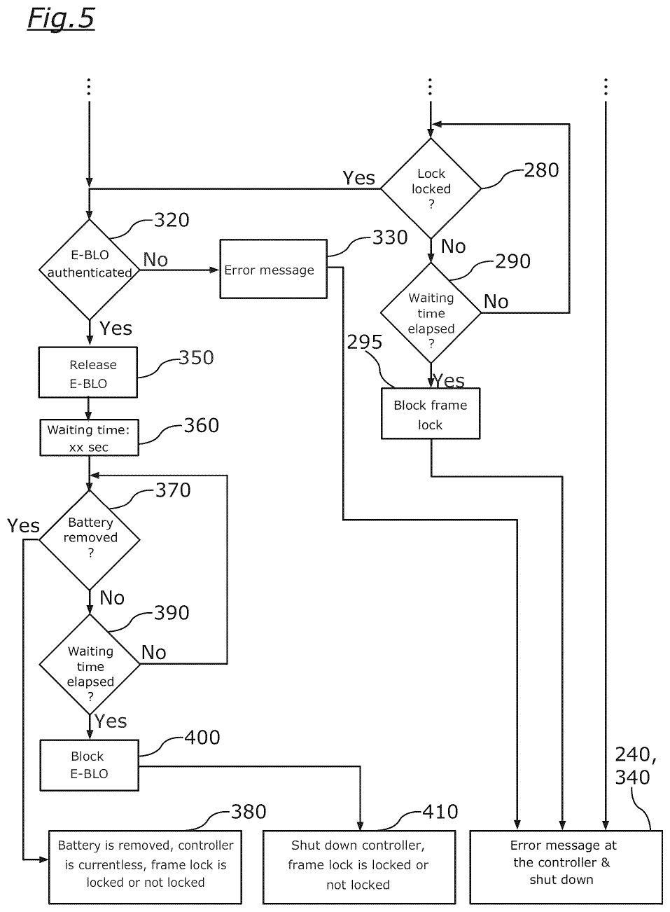

With reference to FIG. 5, the process of locking the frame lock 16 is now explained in more detail for the case that the control unit 12 additionally also controls the battery compartment lock 24, as described in connection with FIG. 1. The initial situation 200 is again a switched-on control unit 12, an open frame lock 16 and a locked battery compartment lock 24.

The user may generally unlock the battery compartment lock 24 at any time when the control unit 12 is switched on and the bicycle is stationary by entering a corresponding unlocking command into the control unit 12 (310), e.g. via the display or a designated switch of the control unit 12.

When such a command is received, the control unit 12 authenticates the battery compartment lock 24 (320), more precisely the actuator, not shown, of the battery compartment lock 24 (second actuator). If the second actuator is not positively authenticated, the control unit 12 generates an error message (330) that may, for example, be displayed on the display of the control unit 12 (340). The control unit 12 then shuts down without the battery compartment lock 24 being unlocked.

In the event of a positive authentication of the battery compartment lock 24, the control unit 12 transmits an unlocking signal to the second actuator (350) and the second actuator unlocks the battery compartment lock 24 for a second predetermined time period (360), for example for a period of up to several tens of seconds, in particular 10 s to 60 s and preferably 10 s to 30 s. During this second predetermined time period, the user may remove the battery from the battery compartment.

If the user removes the battery from the battery compartment (370), the control unit 12 loses its energy supply and switches off without the frame lock 16 having been locked (380).

If the second predetermined time period elapses (390) without the battery having been removed from the battery compartment, the battery compartment lock 24 is locked again by the second actuator (400) and the control unit 12 shuts down without the frame lock 16 having been locked (410).

If the user switches off the control unit 12 (210) to safely park and leave the bicycle, the control unit 12 before shutting down first checks whether the bicycle is still moving (220), for example based on the rotational speed of at least one wheel.

If the control unit 12 detects that the bicycle is not stationary, the control unit 12 generates an error message (230) that may, for example, be displayed on the display of the control unit 12 (240). The control unit 12 then shuts down without the frame lock 16 being locked.

If, on the other hand, the standstill of the bicycle is verified, the control unit 12 next authenticates the frame lock 16 (250), more precisely the first actuator 39 of the frame lock 16. If the first actuator 39 is not positively authenticated, the control unit 12 generates an error message (230) that may, for example, be displayed on the display of the control unit 12 (240). The control unit 12 then shuts down without the frame lock 16 being locked.

In the event of a positive authentication of the frame lock 16, the control unit 12 transmits an unlocking signal to the first actuator 39 (260) and the first actuator 39 moves the latch 23 into the unlocking position (270) releasing the closing hoop for a first predetermined time period, for example for a period of up to several tens of seconds, in particular 10 s to 60 s and preferably 10 s to 30 s (cf. FIG. 2B). During this first predetermined time period, the user may bring the closing hoop 11 of the frame lock 16 into the closed position, i.e. to lock the frame lock 16.

During the first predetermined time period, the control unit 12 checks the closed state of the frame lock 16 by means of the sensor connected to the controller 41.

If the first predetermined time period elapses (290) without the closing hoop 11 having been brought into the closed position, the closing hoop 11 is locked again (295) by the first actuator 39 and the control unit 12 generates an error message that may, for example, be displayed on the display of the control unit 12 (240). The control unit 12 then shuts down without the frame lock 16 being locked.

If, on the other hand, the closing hoop 11 reaches its closed position before the predetermined time period has elapsed, i.e. if the frame lock 16 is closed in time, the control unit 12 authenticates the battery compartment lock 24 (320), more precisely the actuator of the battery compartment lock 24 (second actuator), as described above. If the second actuator is not positively authenticated, the control unit 12 generates an error message (330) that may, for example, be displayed on the display of the control unit 12 (340). The control unit 12 then shuts down without the battery compartment lock 24 being unlocked while the frame lock 16 is locked.

In the event of a positive authentication of the battery compartment lock 24, the control unit 12 transmits an unlocking signal to the second actuator (350) and the second actuator unlocks the battery compartment lock 24 for a second predetermined time period (360), for example for a period of up to several tens of seconds, in particular 10 s to 60 s and preferably 10 s to 30 s. During this second predetermined time period, the user may remove the battery from the battery compartment.

If the user removes the battery from the battery compartment (370), the control unit 12 loses its energy supply and switches off while the frame lock 16 is locked (380).

If the second predetermined time period elapses without the battery being removed from the battery compartment, the battery compartment lock 24 is locked again by the second actuator (400) and the control unit 12 shuts down while the frame lock 16 is locked (410).

Finally, it should be noted that the verification of the standstill of the bicycle (220) is an optional method step that may also be omitted. In this case, the control unit 12 would therefore directly perform step 250 when switching off, i.e. authenticate the actuator 39 of the frame lock 16.

What is claimed is:

1. A method for controlling a frame lock of a vehicle that comprises an electric drive motor, a control unit for controlling the drive motor and a frame lock attached to a frame of the vehicle, wherein the frame lock has a closing hoop, which can be manually brought by a user from an open position into a closed position, and an electrically actuable locking element that locks the closing hoop both in the open position and in the closed position and that can be moved by a first electric actuator into an unlocking position releasing the closing hoop,
wherein the actuator of the frame lock is connected to the control unit and receives an unlocking signal from the control unit for moving the locking element into the unlocking position releasing the closing hoop when the control unit is switched on or off.

2. The method according to claim 1, wherein the control unit carries out an authentication of the user when switching on and only transmits an unlocking signal to the actuator of the frame lock if the user has been positively authenticated.

3. The method according to claim 1, wherein the control unit authenticates the actuator of the frame lock after switching on or switching off and transmits the unlocking signal to the actuator of the frame lock in the event of a positive authentication and/or outputs an error message to the user in the event of a negative authentication and, in the event of a switching off of the control unit, then shuts down.

4. The method according to claim 1, wherein in the event of a switching off of the control unit, the control unit checks the movement state of the vehicle and only transmits the unlocking signal to the actuator of the frame lock when the vehicle is stationary.

5. The method according to claim 1, wherein the actuator of the frame lock, after receiving the unlocking signal, moves the locking element into the unlocking position releasing the closing hoop for a first predetermined time period.

6. The method according to claim 5, wherein the first predetermined time period is a period of up to several tens of seconds.

7. The method according to claim 5, wherein the control unit is connected to a sensor for detecting the open position and closed position of the closing hoop and the control unit confirms a locking of the frame lock to the user and then shuts down if the closing hoop was brought from the open position into the closed position within the first predetermined time period, or outputs an error message to the user and then shuts down if the closing hoop was not brought from the open position into the closed position within the first predetermined time period.

8. The method according to claim 5, wherein the control unit is connected to a sensor for detecting the open position and closed position of the closing hoop and the control unit confirms an opening of the frame lock to the user if the closing hoop was brought from the closed position into the open position within the first predetermined time period, or outputs an error message to the user if the closing hoop was not brought from the closed position into the open position within the first predetermined time period.

9. The method according to claim 1, wherein the closing hoop can be brought from the open position into the closed position against the spring force of a return spring.

10. The method according to claim 1, wherein the control unit is connected to an electric actuator of a battery compartment lock by which the battery compartment lock can be unlocked to enable a removal of a battery received in the battery compartment.

11. The method according to claim 10, wherein the control unit is connected in a wired manner to the electric actuator.

12. The method according to claim 10,
wherein the control unit transmits an unlocking signal for unlocking the battery compartment lock to the actuator of the battery compartment lock in response to a manual user input at the control unit.

13. The method according to claim 10, wherein the control unit, in the event of a switching off of the control unit, automatically transmits an unlocking signal to the actuator of the battery compartment lock if the closing hoop of the frame lock has previously been brought from the open position into the closed position.

14. The method according to claim 12, wherein the control unit authenticates the actuator of the battery compartment lock and transmits the unlocking signal to the actuator of the battery compartment lock in the event of a positive authentication and/or outputs an error message to the user in the event of a negative authentication and, in the event of a switching off of the control unit, then shuts down.

15. The method according to any one of the claim 10, wherein the actuator of the battery compartment lock, after receiving the unlocking signal, unlocks the battery compartment lock for a second predetermined time period.

16. The method according to any one of the claim 15, wherein the second predetermined time period is a period of up to several tens of seconds.

17. The method according to claim 15, wherein the actuator of the battery compartment lock locks the battery compartment lock again after the second predetermined time period has elapsed and the battery has not been removed and, in the event of a switching off of the control unit, the control unit shuts down.

18. A vehicle comprising an electric drive motor, a control unit for controlling the drive motor, a frame and a frame lock attached to the frame, wherein the frame lock has a closing hoop, which can be manually brought by a user from an open position into a closed position, and an electrically actuable locking element that locks the closing hoop both in the open position and in the closed position and that can be moved by an electric actuator of the frame lock into an unlocking position releasing the closing hoop,
wherein the actuator of the frame lock is connected to the control unit, and in that the control unit is configured such that, when switching on and off, said control unit transmits a respective unlocking signal to the actuator of the frame lock for moving the locking element into the unlocking position releasing the closing hoop.
